(19) United States
(12) Patent Application Publication
(10) Pub. No.: US 2024/0159014 A1
(43) Pub. Date: May 16, 2024

(54) POWERED RAKES & ACCESSORIES PROVIDING GRADING

(71) Applicant: Progressive IP Limited, Hamilton (NZ)

(72) Inventor: Rodney Warwick SHARP, Ngaruawahia (NZ)

(21) Appl. No.: 18/509,007

(22) Filed: Nov. 14, 2023

(30) Foreign Application Priority Data
Nov. 15, 2022 (NZ) 794474

(51) Int. Cl. E02F 3/76; E02F 3/815; E02F 3/84

(52) U.S. Cl. CPC E02F 3/7631; E02F 3/8155; E02F 3/844

(57) ABSTRACT

The invention is directed to power rake accessories, with a powered toothed drum, attachable to supporting vehicles. Preferred embodiments include a forward mounted retractable blade portion which can be lowered for levelling/grading operations, or raised for pure raking. Disclosed also are dual blade edge variants with different functionality in forward and reverse operations, and a retractable drum wiping blade.

### FIELD OF INVENTION

The present invention is directed to ground working accessories for attachment to a vehicle, ideally by a quick mounting arrangement. Embodiments of the invention include rotating drums with protruding features able to contact the ground such as preparing soil beds, cleaning construction sites, mixing fines into surfaces, and breaking down the top ground layer into fines. Preferred embodiments also include a blade so levelling, spreading, and grading operations may also be done simultaneously.

### BACKGROUND DESCRIPTION

The preferred ground working accessories of the present invention are within a type commonly referred to as “power rakes”. Power rakes include a powered cylindrical drum with short teeth, often around 30 mm long, protruding from the outer drum surface. Usually the drum spins in the opposite direction to direction of travel at the point closest to the ground. The typical action is a combination of:
larger items are pulled from the ground and flung forward;
brittle, friable, and softer clumps/items are typically fragmented by the impact of the teeth;
the rotating teeth tends to pull smaller fines and fragments, along with some larger items, over the top depending on a number of factors;
larger fragments keep being flung forward until sufficiently broken up to be lifted up and over the rotating drum.

As a power rake progresses across the ground, stones and sods and clumps are typically pulled upwards out of the ground. In a typical situation larger items and fragments are flung forwardly until such time as they have been fragmented sufficiently to be lifted and carried upwardly and over the top of the drum. This is desirable as it leaves a trail of smaller fines behind the drum, which is usually what is wanted.

Towards the top of the powered rotating drum there is a flexible barrier, which prevents large, hard objects, such as sticks and stones from passing over the top of the drum. Clods and sods are generally teased apart. The soil and fines are pulled under the barrier and pass over the top of the drum, where they fall and make a smooth, fine bed. Often the teeth have a solid Tungsten Carbide insert, to prolong tooth life.

A problem often occurs when the ground surface is wet or sticky. Clumps drawn up may start to clog when they encounter the barrier and this requires the operator to try and clear the clogged material which may be by moving the assembly backwards and rotating the rake drum in the opposite direction until cleared. This can significantly slow progress on some ground substrates, and due to ambient weather conditions, and a solution which can go some way towards addressing such clogging issued would be welcomed and useful in the art and industry.

In practice, power rakes are commonly used in a number of landscaping, and resurfacing type applications. The power rakes are not useful for spreading and contouring, but are very good for creating a top ground surface of fines and smaller fragments which can be subsequently spread and levelled—such as by a leveller or grader or bucket. For this reason they are often used on building sites prior to landscaping (to break up pieces of building materials such as broken bricks, lumps of concrete, and other materials which may litter the ground. Anything too big or hard to fragment is typically pushed forward where they can be removed manually or scraped off by a vehicle with a blade or bucket. At the end of the power raking process, the ground can be levelled ready for sowing lawn etc.

The variety of real and potential applications of power rakes are varied, from preparing soil beds for grass, cleaning around house sites, rejuvenating & mixing driveways, mixing fines/lime additives into surfaces (e.g. road working) etc.

As for potential applications, farm tracks, dirt roads, horse stadiums etc can all become rutted or develop hard, and sometimes slippery or dangerous, crusts and top surfaces. A power rake could potentially be used to break through, and up, these top surfaces to be followed by subsequent levelling or grading. The equestrian surfaces often have a mix of sand, rubber, fibre, wax, and additives to keep the surface pliable. The additives can make the material clump together, making traditional grading of the top surface challenging. Power rakes are a potential option for breaking up these clumps and creating a more uniform fine surface, if not for the clogging action where the waxy material can build up ahead of the stone guard—hence the clogging issues mentioned above.

Many farm tracks may also experience clogging issues, especially when formed of sticky or clumping materials such as clay, or with vegetative cover, during some weather conditions. Hence, there are issues if one were to use an existing power rake for such applications and there are limitations in the art as to how power rakes can be effectively used.

If we briefly compare rotating drums with earlier art, stationary (non rotating drum) power rakes do not fragment material or break up surfaces effectively, as there is no rotating drum or other feature allowing for fines to be carried back behind the ‘rake portion’ and for larger pieces to remain ahead (until fragmented/broken into fines). This is accomplished purely by the combing action of the tines. When a stationary type rake is used (i.e. a rake with downward tines or even a toothed drum not rotating) and the base supporting machine moved across the ground, the teeth/tines tear the ground and underlying surface. This causes a high amount of drag, making for very inefficient grading and a messy clumpy finish. Also, there is virtually no opportunity to subsequently (or repeatedly) pulverise or fragment larger clumps drawn before the rake. The poor quality results of stationery rake designs lead to the development of rotating drum power rakes.

As soon as the rake becomes a rotating drum with teeth, the material is fragmented or teased apart, and smaller pieces pass over the top (or underneath). This provides a twofold action of breaking up the ground surface and leaving a trail of finer material behind.

However, a big problem is that a spinning drum with external teeth does not leave a smooth surface. This is one problem of existing Power Rakes—that while they can effectively break a surface into fines, they cannot create a level surface which must be done in a separate operation with a different accessory such as a grader or leveller or the like. Here the significant issue to the industry is that we now have a two pass operation requiring different accessories (either mounted on different vehicles, or changed over on a single vehicle). This significantly increases both time, and expense (for additional accessories and/or vehicles).

Sometimes, during subsequent levelling, it is possible that additional power raking to further break up a section of ground may be required. This then requires swapping vehicles and/or accessories to do a problem patch, which significantly increases time taken and the quality of the final job—especially if extensive re-levelling and finishing is required for the reworked surface portion. Hence the two stage operation of the art is problematic and an option which helps address this issue, and potentially save expense and time taken—and possibly quality of finish—would also be of great value in the art and industry.

Another issue of powered rotating rakes is reliability and maintenance. There is, apart from a supporting chassis, a motor and a rotating drum. There is also a need to support the drum while allowing rotation, which typically involves various bearing designs. In addition, manufacturing tolerances and practices also make it hard to make a perfectly straight drum with a perfectly circular cross-section (of constant diameter) along its entire length. All of these introduce maintenance, design, and reliability issues in the art.

Discussing the manufacturing imperfections of drums—a perfect rotationally balanced drum is expensive to achieve—there is commonly an eccentricity in the rotation of the drum, both in the axis of rotation and balance. To accommodate this, and prevent a machine from destroying itself (or attached components) through vibrations, the art typically employs (often expensive) bearing and mounting and damping solutions. This increases cost, while a failure to address these issues equates to reliability issues. Hence a better solution reducing the need expensive bearings and mounts to achieve reliability would be welcomed and useful in the art.

A further problem for the art is the harsh environment in which power rakes are used. They can get wet, suffer from dust ingress, be subjected to impact, etc. Fibrous materials (certain types of plants usually) also have a habit of working their way into the system and binding things up. Referring to the bearing and mount designs discussed above, many solutions use expensive components (e.g. spherical bearings) which are also susceptible to the presence/ingress of foreign materials. Hence repairs are more expensive, and significant consideration needs to be given to designs to allow easy access for maintenance while stopping the ingress of foreign materials. Any potential advances addressing these issues, especially to reduce costs while improving reliability and ideally (also) ease of access for maintenance would be a useful and welcomed advance in the art, and especially by end users who want less down time, lower repair/maintenance costs, and higher reliability in a wide range of operating conditions.

One of the methods the art has used is to mount the motor for the drum within the drum itself. This makes sealing the motor and drive components against foreign materials easier, but the disadvantages are a larger drum diameter, and extracting the motor for any routine maintenance or repair; typically the entire drum has to be removed from the machine and then disassembled, which increases expense (time) and contributes to operator downtime. Hence any potential advance which addresses these issues would be useful and valued in the art and by end users.

Internal motor rakes use drums which are around 8″ to 10″ in diameter to accommodate the motor and drive assembly. These larger sizes have a disadvantage is that it takes a greater time (and travel distance) to start carrying fines over the top of the drum (an important part of the raking process) when starting from stationary. On smaller sites, and when there is a lot of stop-go manoeuvring, this can be a disadvantage and creates more work for whomever is subsequently grading/levelling the ground surface. Hence any potential advance which facilitates the use of smaller drum diameters would also be useful and of value in the art and to end users.

Further, traditional Power Rakes are manually controlled and have wheel (s) mounted to the outer ends of the drum structure to support the drum and allow it to follow the existing contour of the surface being raked. While this is satisfactory for raking a surface, it doesn't really work when the operator needs to remove or add material to produce a uniform and level surface. Hence, there is a need in the industry for a power rake which can also be used for blending added material and producing a level surface, and without the necessity of a two stage process of raking, followed by levelling with different equipment. No solution to this need exists in the prior art known to the inventor.

It is an object of the present invention to address at least some of the above problems and needs in the industry.

At the very least it is an object of the present invention to provide the public with a useful alternative choice.

Aspects of the present invention will be described by way of example only and with reference to the ensuing description.

### GENERAL DESCRIPTION OF THE INVENTION

According to one aspect of the present invention there is provided a ground working accessory for a vehicle comprising:
a vehicle attachment body portion, including attachment means to a vehicle, and
an accessory body portion;
the body attachment and accessory body portions being connected by a portion connecting linkage set comprising linkages permitting at least vertical travel of the accessory body portion relative to the vehicle attachment body portion;
the accessory body portion comprising a lateral rotatable powered drum assembly, and
a forward blade assembly portion whose bottom edge may be raised and lowered in elevation relative to the lateral rotatable powered drum assembly.

According to another aspect of the present invention there is provided a ground working accessory for a vehicle, substantially as described above, in which the accessory body portion includes side guards on either side thereof to which each end of the lateral rotatable powered drum assembly is attached respectively.

According to another aspect of the present invention there is provided a ground working accessory for a vehicle, substantially as described above, in which the lateral rotatable powered drum assembly has an externally offset driving motor, of which at least part is position on the alternate side of a said side guard than the drum itself.

According to another aspect of the present invention there is provided a ground working accessory for a vehicle, substantially as described above, in which the lateral rotatable powered drum assembly is connected, at its end distal the motor to a flange assembly sandwiching a said side guard within it, and wherein a portion of said flange assembly passes through an aperture in said side guard of greater diameter than the portion passing therethrough, the result characterised by the flange being allowed limited planar movement within the plane of the aperture said sideguard.

According to another aspect of the present invention there is provided a ground working accessory for a vehicle, substantially as described above, in which there is a powered actuator effecting raising and lowering of said forward blade assembly portion.

According to another aspect of the present invention there is provided a ground working accessory for a vehicle, substantially as described above, in which there are stops for limiting the lowest position of the forward blade assembly portion.

According to another aspect of the present invention there is provided a ground working accessory for a vehicle, substantially as described above, in which the lowest portion of said forward blade assembly portion is capable of being below the lowest point on said lateral rotatable powered drum assembly.

According to another aspect of the present invention there is provided a ground working accessory for a vehicle, substantially as described above, in which the bottommost edge of the forward blade assembly portion comprises a pivoting blade edge capable of pivoting about a substantially lateral axis.

According to another aspect of the present invention there is provided a ground working accessory for a vehicle, substantially as described above, in which said blade edge is capable of any one or more of:
pivoting in a rearward direction;
pivoting in a forward direction;
being fixed against pivoting.

According to another aspect of the present invention there is provided a ground working accessory for a vehicle, substantially as described above, in which the forward blade assembly portion in contoured concavely and rearwardly to facilitate driving material in a forward direction before it.

According to another aspect of the present invention there is provided a ground working accessory for a vehicle, substantially as described above, in which the portion connecting linkage sets comprises four linkages in which the four linkages are arranged, when the accessory body portion is not raised nor lowered relative to the vehicle attachment body portion, such that:
a first set of two linkages which are substantially at the same elevation when viewed from the side and are substantially parallel to each other when viewed from above, and
a second set of two linkages which are substantially at the same elevation when viewed from the side and are either:
(i) substantially parallel to each other when viewed from above, or
(ii) converge towards the longitudinal centre axis of the ground working accessory when viewed in plan.

According to another aspect of the present invention there is provided a ground working accessory for a vehicle, substantially as described above, in which the portion connecting linkage sets comprises three linkages in which the three linkages are arranged, when the accessory body portion is not raised nor lowered relative to the vehicle attachment body portion, such that:
a first set of two linkages are substantially at the same elevation when viewed from the side and which are substantially parallel to each other when viewed from above, and
a single additional linkage at a different elevation, when viewed from the side, than the first set of two linkages, and wherein the single additional linkage lies near and substantially parallel to the longitudinal centre axis of the ground working accessory.

According to another aspect of the present invention there is provided a ground working accessory for a vehicle, substantially as described above, in which the linkages of the portion connecting linkage sets include pivotable connections at their ends which permit movement of the accessory body portion comprising one or more of:
up and down movement of the accessory body portion relative to the vehicle attachment body portion, and
rotational movement of the accessory body portion about a rotation axis parallel to the longitudinal centre axis of the ground working accessory.

According to another aspect of the present invention there is provided a ground working accessory for a vehicle, substantially as described above, in which there are provided one or more actuators effecting permitted movements as defined in the previous paragraph.

According to another aspect of the present invention there is provided a ground working accessory for a vehicle, substantially as described above, in which there is provided a forward wheel assembly comprising either or both of a wheel(s), or wheel(s) mounted on a turnable carriage.

According to another aspect of the present invention there is provided a ground working accessory for a vehicle, substantially as described above, in which there is provision for mounting booms for affixing accessories, including guidance sensors.

According to another aspect of the present invention there is provided a ground working accessory for a vehicle, substantially as described above, when attached to a vehicle.

According to a further aspect of the present invention there is provided a ground working accessory for a vehicle comprising:
a vehicle attachment body portion, including attachment means to a vehicle, and
   an accessory body portion;

the vehicle attachment body portion and accessory body portion being connected by a first set of linkages, a second set of linkages, and a third set of elevation adjusting linkages; the first set of linkages characterized by:
comprising two fixed length links with a pivotable connection at each of their ends to the vehicle attachment body portion and accessory body portion respectively, and
wherein, when viewed from the side the pivotable connection points to the body attachment points are substantially at the same elevation as each other.

the second set of linkages characterized by:
comprising two fixed length links each extending between vehicle attachment body portion and accessory body portion, and connecting thereto with pivotable connections, and
when viewed in plan the adjustable length links are disposed one either side of the longitudinal axis of the ground working accessory, and
when viewed from the side the fixed length linkages are at a different elevation to those of the first set of linkages;

the third set of elevation adjusting linkages characterized by:
comprising two adjustable length links each extending between vehicle attachment body portion and accessory body portion, and connecting thereto with pivotable connections, and
when viewed in plan the adjustable length links are disposed one either side of the longitudinal axis of the ground working accessory, and
when viewed from the side the pivotable connections of an adjustable length link at one end is at a different elevation to its pivotable connection at the distal end.

the accessory body portion comprising:
a supporting body portion, and
a rotatable drum accessory aligned parallel to the width of the accessory supporting body portion

According to another aspect of the present invention there is provided a ground working accessory, substantially as described above, in which the pivotable connections of each of the first and second sets of linkages to the accessory body portion, when viewed from the front, comprise one or more of: a rectangle, or parallelogram.

According to another aspect of the present invention there is provided a ground working accessory, substantially as described above, in which one end of each fixed length link of either, but not both, of the first and second linkages sets is connected to either the vehicle attachment body portion or accessory body portion at a point at or near to the longitudinal axis of the ground working accessory when viewed in plan;

According to another aspect of the present invention there is provided a ground working accessory, substantially as described above, in which the pivotable connections of each of the first and second sets of linkages to the accessory body portion, when viewed from the front, form substantially a triangle.

According to another aspect of the present invention there is provided a ground working accessory, substantially as described above, in which the pivotable connections of each of the first and second sets of linkages to the vehicle attachment body portion, when viewed from the front, form substantially a triangle.

According to another aspect of the present invention there is provided a ground working accessory, substantially as described above, which includes at least one movable flexible barrier portion positionable between at least two positions, a first position which is in proximity to either or both the outer surface of the rotatable drum assembly and protruding features thereof, and a second position which is clear of either or both the outer surface of the rotatable drum assembly and protruding features thereof.

According to another aspect of the present invention there is provided a ground working accessory, substantially as described above, in which the flexible barrier portion extends substantially the entire width of the rotatable drum assembly.

According to another aspect of the present invention there is provided a ground working accessory, substantially as described above, in which the flexible barrier portion has a pivotable connection to allow it to move between first and second positions.

According to another aspect of the present invention there is provided a ground working accessory, substantially as described above, in which control of the position of the flexible barrier portion is by any one or more of: an actuator, a spring bias, a mechanical connection, a mechanical locking mechanism.

According to another aspect of the present invention there is provided a ground working accessory, substantially as described above, in which at either or both ends of the accessory body portion there is provided a side-wing portion extending forwardly of the accessory body portion and pivotable about a vertical axis.

According to another aspect of the present invention there is provided a ground working accessory, substantially as described above, in which said side-wings can extend forwardly of the blade portion when it is in a lowered position.

According to another aspect of the present invention there is provided a ground working accessory, substantially as described above, in which the first, second and third set of linkages, and their respective pivotable connections, cooperate to allow the accessory body portion rotate in a roll motion about a horizontal rotational axis substantially aligned with the longitudinal axis of the ground working accessory when viewed in plan.

According to another aspect of the present invention there is provided a ground working accessory, substantially as described above, in which third set of linkages can cooperate to adjust the relative elevation of the accessory body portion to the vehicle attachment body portion.

According to another aspect of the present invention there is provided a ground working accessory, substantially as described above, in which also includes a blade portion positioned parallel to, and forward of, the rotatable drum accessory and wherein the blade portion is pivotably connected at either end to the accessory body portion in a manner allowing it to pivot forwardly and upwardly from a downward position.

According to another aspect of the present invention there is provided a ground working accessory, substantially as described above, which includes at least one linkage for controlling the pivoting and position of said blade portion.

According to another aspect of the present invention there is provided a ground working accessory, substantially as described above, which includes a locking mechanism for locking the blade portion in an upwardly pivoted raised position.

According to another aspect of the present invention there is provided a ground working accessory, substantially as described above, in which when viewed from the side the first set of links are aligned with each other.

According to another aspect of the present invention there is provided a ground working accessory, substantially as described above, in which when viewed from the side the second set of links are aligned with each other.

According to another aspect of the present invention there is provided a ground working accessory, substantially as described above, in which when viewed from the side the first set of links at a higher elevation than the second set of links.

According to another aspect of the present invention there is provided a ground working accessory, substantially as described above, in which when viewed from the side the first set of links are substantially parallel to the second set of links.

According to another aspect of the present invention there is provided a ground working accessory, substantially as described above, in which the pivotable connection points of the adjustable length links of the third set of linkages are at a higher elevation, when viewed from the side, where they connect to the vehicle attachment body portion than at their connection at the distal end.

According to another aspect of the present invention there is provided a ground working accessory, substantially as described above, in which a said pivotable joint connection on a said fixed length link comprises one or more of: a spherical bush, a bearing, and a ball joint.

According to another aspect of the present invention there is provided a ground working accessory, substantially as described above, in which a said pivotable joint connection on a said adjustable length link comprises one or more of: a spherical bush, a bearing, and a ball joint.

According to another aspect of the present invention there is provided a ground working accessory, substantially as described above, in which the attachment means for a vehicle on the vehicle attachment body portion is positioned at or near the centre longitudinal axis of the ground working accessory when viewed in plan.

According to another aspect of the present invention there is provided a ground working accessory, substantially as described above, in which the attachment means for a vehicle comprises a quick mounting type attachment mechanism.

According to another aspect of the present invention there is provided a ground working accessory, substantially as described above, in which power to the powered drum accessory is transmitted by one or more of: direct drive, a geared mechanism, a transmission, and a belt drive.

According to another aspect of the present invention there is provided a ground working accessory, substantially as described above, in which the power source for the powered drum accessory comprises one or more of: a hydraulic motor, an electric motor, a power take off source on a vehicle to which the ground working accessory is attached.

According to another aspect of the present invention there is provided a ground working accessory, substantially as described above, in which the power and drive arrangement for the powered drive accessory allows for powered rotation in both clockwise and anticlockwise directions when viewed from an end.

According to another aspect of the present invention there is provided a ground working accessory, substantially as described above, in which the power and drive arrangement for the powered drive accessory allows for the option of the powered drive accessory free-wheeling without power.

According to another aspect of the present invention there is provided a ground working accessory, substantially as described above, in which there is provided a forward wheeled assembly attached to the vehicle attachment body portion.

According to another aspect of the present invention there is provided a ground working accessory, substantially as described above, in which the wheeled assembly is rotatably attached to a forwardly extending arm from the vehicle attachment body portion.

According to another aspect of the present invention there is provided a ground working accessory, substantially as described above, in which the forwardly extending arm is hinged to allow the wheeled assembly to be pivoted up and towards the vehicle attachment body portion.

According to another aspect of the present invention there is provided a ground working accessory, substantially as described above, in which there is provided attachment means for attachment of sensors associated with a proprietary guidance and/or positioning system.

According to a further aspect of the present invention there is provided a ground working accessory, substantially as described above, in combination with a vehicle.

According to a further aspect of the present invention there is provided a ground working accessory for a vehicle comprising:
a vehicle attachment body portion, including attachment means to a vehicle, and
an accessory body portion;

the vehicle attachment body portion and accessory body portion being connected by a first set of linkages, a second set of linkages, and a third set of elevation adjusting linkages;

the first set of linkages characterized by:
comprising two fixed length links with a pivotable connection at each of their ends to the vehicle attachment body portion and accessory body portion respectively, and
one end of each fixed length link connected to either the vehicle attachment body portion or accessory body portion at a point at or near to the longitudinal axis of the ground working accessory when viewed in plan;
and wherein, when viewed from the side the connection points at or near to the longitudinal axis are substantially at the same elevation.

the second set of linkages characterized by:
comprising two fixed length links each extending between vehicle attachment body portion and accessory body portion, and connecting thereto with pivotable connections, and
when viewed in plan the adjustable length links are disposed one either side of the longitudinal axis of the ground working accessory, and
when viewed from the side the fixed length linkages are at a different elevation to the first set of linkages;

the third set of elevation adjusting linkages characterized by:
comprising two adjustable length links each extending between vehicle attachment body portion and accessory body portion, and connecting thereto with pivotable connections, and
when viewed in plan the adjustable length links are disposed one either side of the longitudinal axis of the ground working accessory, and
when viewed from the side the pivotable connections of an adjustable length link at one end is at a different elevation to its pivotable connection at the distal end;

the accessory body portion comprising:
a supporting body portion, and
a rotatable drum accessory aligned parallel to the width of the accessory supporting body portion, and
a motor with drive system at at least one end of the accessory body portion for rotationally driving the rotatable drum assembly, and
including at least one movable flexible barrier portion positionable between at least two positions, a first position which is in proximity to either or both the outer surface of the rotatable drum assembly and protruding features thereof, and a second position which is clear of either or both the outer surface of the rotatable drum assembly and protruding features thereof.

For clarity of description preferred embodiments, such as in the attached drawings, will largely be referenced though it should be appreciated that the skilled addressee of the art, in light of the instructions and disclosure in this specification, will be able to adapt or modify embodiments of the invention which meet their specific needs.

Within the context of this specification the terms roll, pitch, and yaw will typically be used as in aeronautics with roll being arcuate movement within the yz plane (x being longitudinal, y being transverse, and z being vertical). Yaw is arcuate movement within the xy plane, and pitch being arcuate movement within the xz plane.

The terms sagittal, coronal, and transverse planes will be used as in the medical field, with saggital being xz vertical plane, coronal being yz vertical plane, and transverse being the xy horizontal plane. Hence the sagittal plane is the vertical axis passing through axis (5) in FIG. 2.

For clarity of description preferred embodiments, such as in the attached drawings, will largely be referenced though it should be appreciated that the skilled addressee of the art, in light of the instructions and disclosure in this specification, will be able to adapt or modify embodiments of the invention which meet their specific needs.

Generally a ground working accessory of the present invention will comprise two main body portions—a vehicle attachment body portion for attaching to a vehicle, and an accessory body portion which includes the parts which work the ground. Linkages separate the vehicle attachment body portion and accessory body portion and allow limited movements relative to each other—this is discussed further below.

In preferred embodiments of the present invention there are two main ground working portions—a rotatable drum portion for working the ground, and a blade portion for levelling the ground. In preferred embodiments the two may be used in combination when present, or the rotating drum only. Simpler embodiments may only allow the two to be used in combination, though preferred embodiments of the invention allow the drum to be used with the blade out of the way for purely raking operation.

Ideally the blade is placed ahead of the rotating drum assembly, for normal forward movement when the ground working accessory is placed at the front of a vehicle. In what will be called a ‘rest’ position the blade extends laterally (relative to the front/rear longitudinal axis of the ground working accessory—(5) in FIG. 2). However in more preferred embodiments a roll type rotation of the accessory body portion (and its included accessories) about the longitudinal axis (5) is possible and thus the ‘rest’ position is, when viewed from above, when the blade is perpendicular sagittal plane of the ground working accessory—i.e. horizontal to both the nominal axial and ground planes.

FIGS. 7 and 8 illustrate a roll position of the accessory portion relative to the vehicle mounting portion. This roll angle can be both clockwise and anticlockwise (when viewed from the front) and allows the accessory to be used on ground surfaces which are not flat or purely horizontal. This provides a user with the ability to follow ground contours more closely, which can provide a better raking action when the drum (when viewed from the front) can remain parallel to the ground it is acting on. Otherwise, we can arrive at situations where only one end or portion of the drum is actually interacting with the ground, instead of its entire length. Hence, embodiments which allow for roll rotations of the accessory portion have the potential to improve performance in some applications and situations. The roll rotation is provided by the adopted linkage arrangement on an embodiment, which will be discussed in more detail later.

Parallel to the blade portion is the rotating drum portion, which typically comprises a drum with outwardly protruding features of a type/design designed for a particular type of ground working effect. These are typically studs or bosses, often with hardened or tungsten carbide tips, or the like. These may be organised in varying patterns on the outer surface of the drum.

A blade portion is provided on preferred embodiments. This allows for the accessory to perform levelling and grading type operations on ground surfaces. In these preferred embodiments the blade is alterable between operating and non-operating positions (see below) so that the accessory can be used purely for power raking, or for levelling (or a combination of the two). In the prior art discussion it has been mentioned that the art has proceeded down a path where raking and levelling are done separately in separate operations. In the present invention the user can power rake a surface and then subsequently level the surface with a blade without changing accessories. However, in practice, additional potential advantages can be attained. For instance, in applications such as top surface aggregate blending (e.g. to blend added aggregate to a top surface being broken up) there can be a need for repetitive alternate raking and blending—the surface is raked to create fines and blend materials, then levelled, and the process repeated until sufficient blending has occurred; this is not practical with traditional two stage processes using different accessories. Hence there are applications where preferred embodiments of the present invention can make previously untenable operations viable.

Further more, preferred embodiments can allow forward travel of the accessory with the blade raised to comprise a power raking operation, followed by rearward travel of the accessory with the blade lowered so that another power raking pass is (optionally) performed immediately followed by levelling. With a single forward and backward pass the operator can perform both raking and levelling. If the operator considers a further raking or levelling pass is required they can repeat the process, using the option of the blade raised or lowered to achieve the specific result they want. This combination of actions has not been provided nor possible in the art and the direction it has taken, and thus preferred embodiments of the present invention can provide operational features and versatility hereto before not known, and with the possibility of opening up new applications for power raking equipment as well as making previously uneconomic operations simpler and time/cost effective. At the very least, they can provide users with more flexible options regarding use and operation, and it is anticipated the invention will be put to new uses not previously considered for a power rake. Additionally, preferred embodiments can make equipment acquisition more viable for users balking at purchasing separate power rakes and levellers to complete the types of task to which the present invention is directed.

Typically the blade is positioned forward of the drum (during forward travel) but variations can exist. By placing the blade portion forwardly, the option exists to pivot the blade—ideally near its top. This allows the blade's edge to be lifted, typically by the upward rotation of the blade portion. This may be manual but typically an actuator is provided on preferred embodiments allowing operation by the user from the vehicle. The blade portion may then be locked or otherwise held in position for when operation only requires use of the rotating drum portion. As previously mentioned, simpler embodiments may not provide for pivoting of the blade portion.

Various embodiments may have blade portions with front and/or rear edges to allow levelling actions in both forward and reverse directions. The blade edges, whether double or single, may be also pivoted to allow them to trail in a particular direction. For instance an operator may not require full blade levelling when travelling in one direction (e.g. reverse) and thus the pivoting blade edge may pivot into a trailing position to minimise the levelling action. Where pivoting is provided a simple lock mechanism may be provided to turn this feature on or off. Pivoting may be configured in different embodiments to trail in forward or reverse directions as required. Various stops can limit the degree of pivoting (where provided) in either forward or reverse direction operation.

The blade portion is typically contoured to encourage material on the ground surface (such as when adding aggregate) to roll, reducing segregation of material. This is also useful when the operator wishes to perform a pass to push larger unbreakable fragments and foreign material off the ground area being worked—i.e. clearing the site of larger foreign items.

As previously mentioned the blade can be operated manually or by other means, preferable of a rigid nature, such as a hydraulic cylinder or linear actuator. It would be preferable for the blade actuating mechanism to be remotely operated from the operator's station. The type and design of actuator is not important.

The blade portion may rest against fixed or adjustable stops, so the blade is accurately positioned when lowered. When the accessory is used in conjunction with guidance mechanisms—such as laser levelling systems—adjustable stops can be useful for calibrating the height of the blade though typically the sensor height will be adjusted.

Preferably a side wing may be provided either side of the blade portion. This may be fixed though in more advanced embodiments the side-wings are able to pivot about a vertical axis, and to be retained in a preferred position. These are useful when the ground working accessory is performing a grading and levelling type action, such as when incorporating additional material. This helps reduce furrows either side of the ground working accessory as it is travelling across the ground.

In preferred embodiments an external mounting system is used for the motor powering the drum. As mentioned in the prior art discussion, internal motor mounting has some disadvantages including drum diameter and maintenance. Feedback from the industry is that a smaller diameter drum has some advantages, including faster startup, less rotational inertia, and quicker pickup of fines and carrying them up and over the drum. For an operator wishing to quickly cover a ground area with multiple forward and reverse passes, and multiple stops, a drum which can very quickly carry fines up and over avoids end zones (at the end of passes) without fines. Hence a smaller diameter drum, e.g. around 6″ as opposed to 8″ or 10″ can significantly reduce these issues.

However mounting the motor externally raises some other issues, such as exposure to all the ground material being raked and levelled. Keeping foreign material out of moving parts in the motor could be problematic. Hence in preferred embodiments the motor is positioned externally to the side wings/shields on the accessory portion, allowing them to act as a shield against material being worked. This also makes the motor more accessible for repair, maintenance, and replacement.

Ideally the motor drive shaft passes into the driving end of the drum to mate with an internal bearing and seal assembly. In preferred embodiments the end piece of this internal assembly, sealing the end of the drum, is aligned with the drive shaft bearings of the motor.

At the drum's retaining end, distal to the motor, a retaining flange assembly is provided in the side wing/shield of the accessory body portion. For simplicity of construction this can be a two piece assembly, one piece either side of the side shield and fastened together (though see detailed description of drawings for more information). The accommodating aperture in the side shield should be larger (e.g. 3-6 mm but varies according to need and dimensions of other components etc.) than the portion of the flange assembly which passes therethrough. This is to allow movement of the flange within the plane of the side shield in that region. As has been mentioned in the prior art discussion, most drums have eccentricities due to manufacturing methods and tolerances. Hence the true rotational centre and axis of rotation can vary slightly between each end. To accommodate this out of true rotational movement the prior art has resorted to the use of internal spherical bearings to accommodate these rotational variances. However spherical bearings are relatively expensive, and also susceptible to damage (more so than regular cylindrical bearings) from foreign material working its way into the interior of the drum. In preferred embodiments with the floating movement style flange, these movements can be accommodated without the use of an internal spherical bearing—a much less expensive, and more reliable (less susceptible), alternative arrangement. This also allows a traditional cylindrical type bearing to be used internally, and in preferred embodiments, a labyrinth type mounting system making it harder for fibrous and foreign materials to find their way into the bearing.

An earlier design of the applicant in the prior art (EP 3623532 A1) describes a forward accessory mount, ahead of a blade, which can be raised and lowered when needed.

However there are a number of considerations of this arrangement which do not make it suitable for all applications, and which the present invention addresses.

One consideration is that the rotating drum can introduce vibrations and needs a very sturdy mounting system which will not be damaged over time by vibrations—particularly from out of balance situations where ground material adheres to the teeth/drum, and also from eccentricities in the fabrication of the drum (see discussion elsewhere herein). While the considerations are readily overcome with sturdy manufacture, this significantly increases the weight of the components. In many power rake applications, there is a need for a compact device which can be used on small vehicles, including mini skid steer loaders and even one-person stand-on equivalents. Here weight is a very important consideration, and these devices could not support or mount a device such as described in EP 3623532 A1). This has necessitated a complete redesign and design approach to meet the needs of the industry and art. Consequently the present invention makes use of a fixed height drum, which can be securely mounted directly to the chassis of the accessory body portion. The absence of heavy raisable mounting mechanisms has significantly reduced the overall weight while also providing means for sturdy support of a rotating drum.

Further providing a raisable blade portion allows for power rake only usage when required, while a raisable blade portion is significantly less in weight (and demand) than a heavy drum lifting mechanism. The forward mounting of the blade also allows large material to be removed by pushing ahead. The arrangement also is better for applications requiring the blending of aggregate materials into a top surface being levelled, and the pivoting blade edge of some embodiments can add further functionality.

The linkages, to be more fully described later, allow the accessory body portion to be raised or lowered relative to the ground—hence the rotating drum portion is also altered in elevation according to the ground. This allows an operator to control the ground elevation according their needs. To be described later, the linkages in preferred embodiments also allow the roll angle of the accessory body portion (and thus the mounted accessories) to be changed by rotation about a horizontal axis parallel to the previously mentioned longitudinal axis of the ground working accessory. This feature is particularly useful for on cambered surfaces or when contouring the ground during operation. It is also particularly useful when a control system coupled to a guidance system (e.g. 3D, 2D, 2.5D, etc as commonly used in construction) is employed.

In preferred embodiments the position of the blade when fully down is chosen to limit the closest distance of approach of the rotating drum to the ground. This need not be provided, but can be useful for maintaining an ideal relationship between blade and drum for when raking with levelling/smoothing operations are performed.

The drum is typically capable of one or more of: clockwise rotation when viewed from the lefthand side, anticlockwise rotation when viewed from the lefthand side, freewheeling, and locked against rotation. The drum is typically driven and power delivery may comprise one or more of a direct drive system, a belt drive arrangement, a transmission or gearbox, a geared or mechanical arrangement, or a connection to a power take-off on the vehicle.

The motive means for the drum may be one or more of: hydraulic motors, electric motors, and combustion engines etc. A single motor may be provided though in preferred embodiments a motor is provided at each end of the drum—allowing smaller more compact motors to be used which do not extend either side of the accessory body portion too far. A hydraulic motor is preferred in most embodiments, as the vehicles to which the grounding working accessory is likely to be attached usually have hydraulic outputs and controls.

In preferred embodiments there is provided a flexible barrier portion. This typically comprises a blade of a relatively stiff but flexible material, and ideally extends along the entire width of the drum and in proximity to its outer surface (or the reach of the drum's protrusions). It is ideally mounted, in preferred embodiments, in a manner allowing the flexible end of the barrier to be alterable between close proximity to the outer surface of the drum or its features when present, and in a position distanced therefrom. The barrier can help break up clumps of material when in proximity to the blade, by acting as a barrier to large clumps getting past. Ideally a pivoting system (like for the blade) is used to allow the distance between the free flexible edge of the barrier and the drum/protrusions to be changed. Various mechanisms, such as automatic or manual or semiautomatic, may be used to change and maintain the position of the flexible barrier system.

The alterable position barrier system helps counter situations where clogging occurs, as previously mentioned in the prior art. By moving it away from the drum's teeth, material (e.g. wet or sticky material) can more readily pass over the top of the drum thereby avoiding any need for the operator to manually unclogged a fixed blade system. There are other situations, than wet and clumpy ground, where the operator may also wish to withdraw the flexible barrier away from the rotating drum, and thus this feature provides more functionality to the operator in different situations and applications.

In preferred embodiments there is also provide a forward support wheel or carriage. This connects to the body mounting portion, often simply by a forward extending arm. This helps stabilise the pitch of the ground working accessory, especially when smaller and lighter vehicles are being used. The forward support arm may be hinged to allow the wheel/carriage to be folded up and over for storage, or when not needed during operation.

In various embodiments of the present invention the fixed length links (first and second sets) may adopt several different arrangements. In a preferred embodiment, discussed first in the detailed description below, the first and second sets of links are substantially parallel to each other when viewed from the side. In this view each link in a set are at substantially the same elevation when viewed from the side. This arrangement allows for changes in elevation of the accessory body portion relative to the vehicle attachment body portion with minimal or negligible changes in pitch of the accessory body portion (and thus its blade if fixed in position).

The second embodiment discussed in the drawing description section also has the same general geometry in the first and second link sets when viewed from the side, and also minimises pitch changes during elevation changes of the accessory body portion.

Where there is a difference between the two embodiments of the previous paragraphs is visible when viewed from above. In the first embodiment the two links of the first link set converge to mount to the vehicle attachment body portion at or near the central longitudinal axis of the accessory. Hence the two links are diagonal relative to the central longitudinal axis when viewed from above. This provides additional stability against relative lateral movement of the accessory body portion relative to the vehicle attachment body portion without any additional bracing elements. As can be appreciated the diagonal links could be placed as the lower link set.

In the second embodiment mentioned additional bracing elements may be required, which may be an actuator for embodiments where relative lateral movement of the accessory body portion relative to the vehicle attachment body portion is desired—such as in a side shifting variation embodiment where the lateral position of the accessory body portion is meant to be adjustable. Other mechanical variations to an actuator can be used, but generally at least one adjustable length link, maintainable in various lengths, will be used in various embodiments to set and hold the lateral side-shifted position.

It should be noted that variations of the link arrangements may be employed. For instance the diagonal arrangement of the first embodiment discussed above may have the mounting positions reversed so that the links converge towards the central longitudinal axis at the accessory body portion instead. Other variations are where the diagonal arrangements are in the second link set rather than the first—in either of the two possible converging arrangements. This will be largely a matter of user choice, and sometimes to accommodate available parts etc. In the preferred embodiments, generally the lower second set will be parallel to the central longitudinal axis when viewed from above. In practice this would generally accommodate thicker lower fixed length links as this is often at a similar level to the rotating drum—where most load transmission occurs. Links parallel to the longitudinal axis do not need to accommodate a sideways force component such as in a diagonal link.

Additionally, having a diagonal brace arrangement near the bottom of the accessory could end up gathering loose material on the ground, or flung at it from the rotating drum. Links parallel to the longitudinal axis is more likely to allow this to slide past.

As can be appreciated, the user is afforded a selection of possible fixed link arrangements to accommodate specific requirements they have. Reference is made to patent publication WO 2015/190937 A1, WO 2022/009076 A1, and EP 3623532 A1 of the prior art, which describe link arrangements of the prior art which may be employed in various embodiments of the present invention to effect relative movement between the vehicle mounting and accessory body portions of the accessory. It is considered that the skilled addressee of the art will, in conjunction with the descriptions of these documents, be able to better understand and implement various link arrangements given also the disclosure herein.

At each end of the fixed links is a pivotable connection. This may allow pivoting substantially within a single plane, with limited variations there from, or may allow a wider range of pivotable motion, such as up/down and left/right and angles in between. Hence a range of pivotable arrangements can be used in varying embodiments—giving the user a range of choice for construction and repair. As a general guide, connections which prevent, reduce, or are resistant to the ingress of foreign materials which could damage or affect function of a connection are preferred. Hence, generally preferred options include one or more of: ball joints (preferably sealed), spherical bushes (preferably with a resilient material such as a synthetic rubber), and various other bush and joint arrangements such as used in vehicle suspensions (as an example) which are typically designed in conditions where they are exposed to the weather, and road materials flung at them—not too dissimilar from the conditions of use for the present invention.

For further protection against the environment a sleeve or cover can be additionally and optionally placed over connections, or link and connection assemblies.

In preferred embodiments of the present invention there is provided elevation changing means for changing the elevations of the accessory body portion relative to the vehicle attachment body portion. While a single element such as an actuator may be used, preferred embodiments use a third linkage set comprising ideally two adjustable length links such as actuators. When viewed from above these are ideally disposed substantially equidistant from the longitudinal axis. More preferably they are disposed towards the ends of the accessory body portions for stability during roll angle adjustments where provided. However, in some embodiments the elevation changing actuators may be placed further inwardly (closer to the longitudinal axis).

By providing for roll angle adjustment, the two actuators/adjustable links of the third set of linkages can be operated independently so as to allow one end of the accessory portion to be at a different elevation to the ground than its other end. This allows the vehicle operator to perform operations where a camber or slope may be present or need to be formed into the ground. There are a number of reasons why this option is desirable in practice, and thus in the two illustrated embodiments of the detailed description this feature is provided. The fixed link arrangements of those examples, as well as in variations mentioned above, allow for the roll angle adjustments.

The present invention is adaptable for use with various guidance systems such as GPS, 2D systems, 2.5D systems, 3D systems and simpler guide arrangements—such as commonly used in building and constructions. Most surveying and theodolite systems can be coupled with such systems, or at least a projected laser light guide. The present invention may provide mounting poles or fixtures for attaching sensors for use with such sensors, and may provide information to a control system coupled to the hydraulic or actuator controls on the unit (or vehicle cab) or provide feedback to the vehicle operator for manual operation. Such systems are well used and known in the environments such as the present invention will be used, and on vehicle mounted levelling accessories. For that reason they will not be discussed in more detail, and will be considered to be something which the skilled reader would be familiar with.

The nature and operation of the embodiment described above will be better described with reference to the drawings.

### DESCRIPTION OF DRAWINGS

FIG. 1 is a side diagrammatic view of a preferred embodiment of the present invention,

FIG. 2 is a top plan diagrammatic view of the embodiment of FIG. 1,

FIG. 3 is a rear-underneath perspective view of the embodiment of FIG. 1

FIG. 4 is an underneath perspective view of the embodiment of FIG. 1,

FIG. 5 is a side diagrammatic view of the embodiment of FIG. 1 with the accessory body portion lowered,

FIG. 6 is a top-side perspective diagrammatic view of the embodiment of FIG. 1 with the blade level,

FIG. 7 is a front diagrammatic view of the embodiment of FIG. 1 with the accessory body portion having a roll angle away from horizontal and with the blade in the downward operational position,

FIG. 8 is a front diagrammatic view of the embodiment of FIG. 1 with the accessory body portion having a roll angle away from horizontal and with the blade in the upward retracted position,

FIG. 9 is a close-up cut-away perspective view of the embodiment of FIG. 1 showing the flexible blade in an operational position,

FIG. 10 is a close-up cut-away perspective view of the embodiment of FIG. 1 showing the flexible blade in a retracted position,

FIG. 11 is a partial cut-away side view showing the drum portion,

FIG. 12 is a bottom perspective diagrammatic view of a second embodiment of the present invention with a different link arrangement,

FIG. 13 is a side partly cut-away diagrammatic view of the accessory body portion of a dual blade edged embodiment of the present invention travelling in a forward direction, and

FIG. 14 is a side partly cut-away diagrammatic view of the accessory body portion of a dual blade edged embodiment of the present invention travelling in a rearward direction, and

FIG. 15 is a partial exploded diagrammatic view of an embodiment of the present invention, and

FIG. 16a is a partial coronal plane cut-away view of the drum and drum support assembly of a preferred embodiment of the present invention,

FIG. 16b is an enlarged portion of FIG. 16a focusing on the drum retaining end, and

FIG. 16c is an enlarged portion of FIG. 16a focusing on the drum powered end, and

FIG. 17 is a side diagrammatic view of the accessory body portion of an embodiment of the present invention with the blade portion raised.

### DESCRIPTION OF PREFERRED EMBODIMENT

With reference to the drawings and by way of example only there is provided an embodiment of a ground working accessory (generally indicated by arrow 1) for a vehicle (not shown) comprising:
a vehicle attachment body portion (2), including attachment means (4) to a vehicle, and
an accessory body portion (3);

The attachment means (4) ideally comprises the commonly used quick mount, present on many vehicles and accessories. In plan view, this is typically centrally mounted along the central longitudinal axis (5).

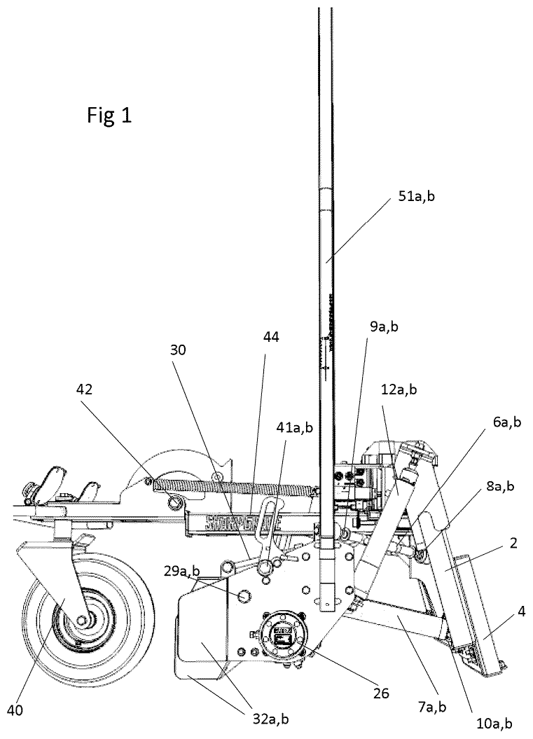

In the embodiment of FIG. 1 the vehicle attachment body portion (2) and accessory body portion (3) are attached by:
a first set of linkages (6a, b) characterized by:
   two fixed length links (6a, b) with a pivotable connection at each of their ends (8a, b) to the vehicle attachment body portion (2) and at the distal end (9a, b) to accessory body portion (3) respectively, and
   wherein, when viewed from the side (FIG. 1) the pivotable connection points (8a, ) to the body attachment are substantially at the same elevation as each other.
the second set of linkages characterized by:
   comprising two fixed length links (7a, b) each extending between vehicle attachment body portion (2) and accessory body portion (3), and connecting thereto with pivotable connections (10a, b) and (11a, b) respectively, and
   when viewed in plan the adjustable length links (7a, bare disposed one either side of the longitudinal axis (5) of the ground working accessory (1), and
   when viewed from the side (FIG. 1) the fixed length linkages (7a, b) are at a different elevation to those of the first set of linkages (6a, b).

The fixed length links (6a, 6b) (7a, 7b) are typically of rod or tube as appropriate. Typically the pivoting connections (8a, b) (9a, b) (10a, b) (11a, b) are a flexible bush ball joint. A cover piece may be specified to resist the ingress of foreign matter. The points of connection to the body and accessory portions (2, 3) may be reinforced or of suitable strength at those connection points.

Viewed from the side (FIG. 1) the two fixed lengths of the first set lie in the same plane, as do the two fixed lengths of the second set. These planes are substantially parallel to each other, and remain so during changes in elevation of the accessory body portion (3), though the distance between the planes typically changes as the elevation of the mounting portion (3) changes.

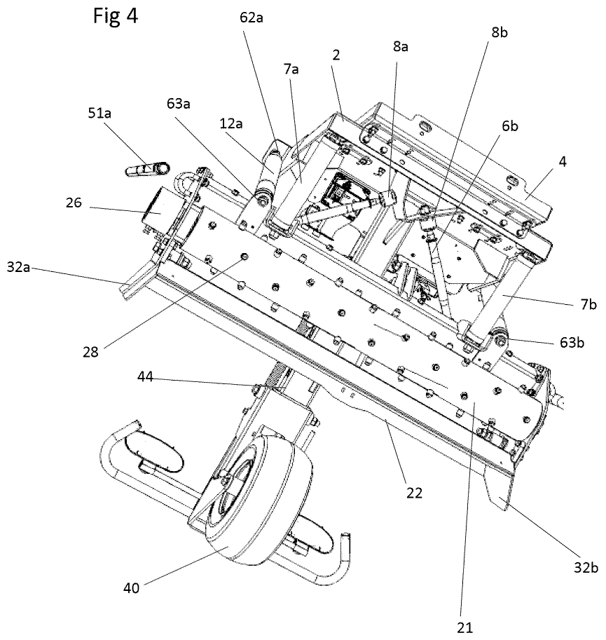

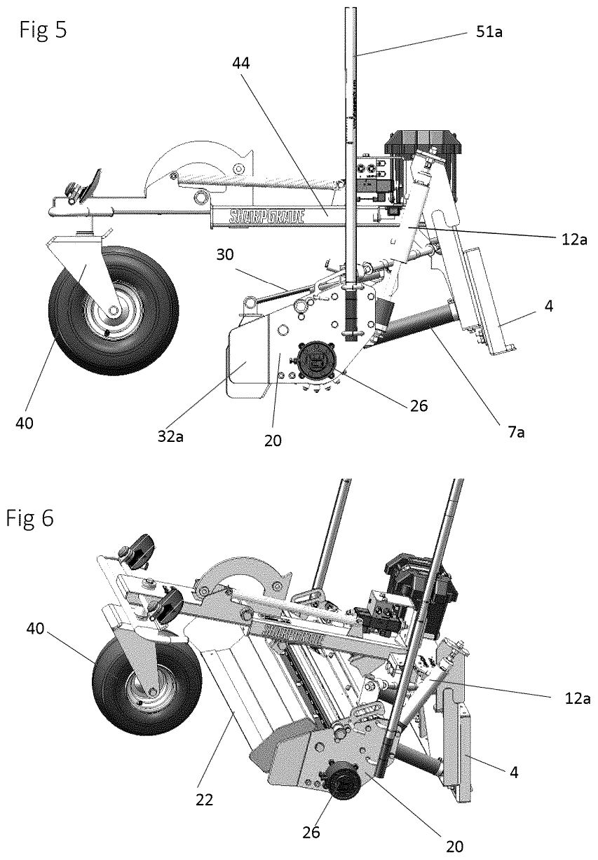

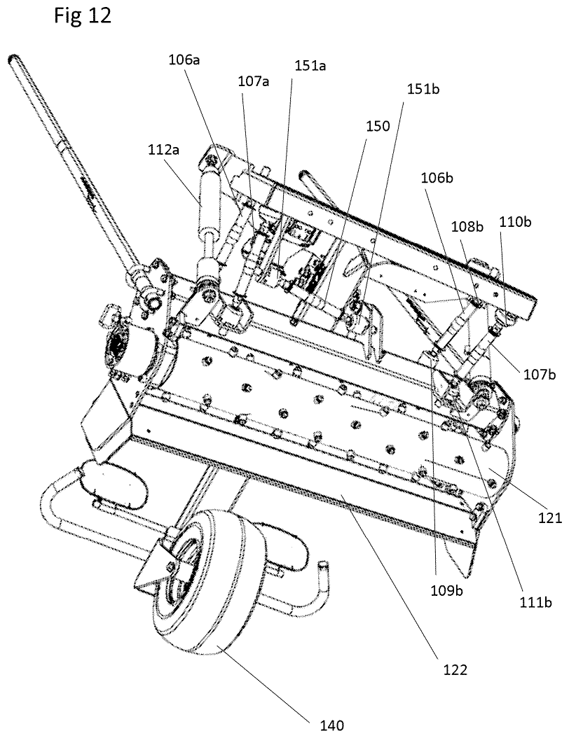

Viewing FIG. 4 it can be seen that the accessory body portions (8a, 8b) for this embodiment are positioned close to the central longitudinal axis (5) and the connected links are diagonal (when viewed from above) relative to the axis (5). This resulting triangular arrangement provides stability against lateral (sideways) movement of the accessory portion—as would be the case in the parallel link type arrangement of FIG. 12 where additional bracing (150) is required.

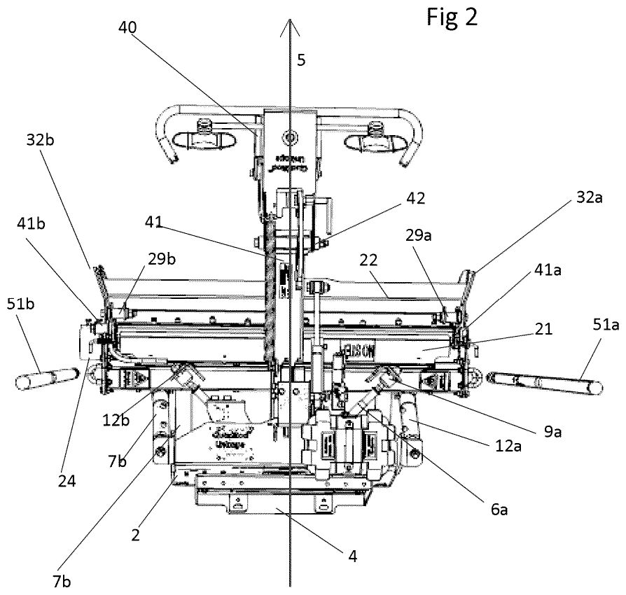

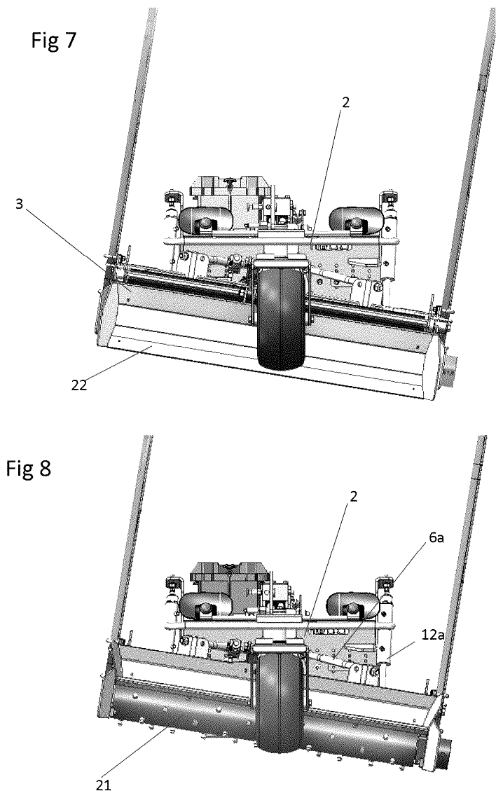

A third adjustable linkage set comprises two actuators (12a, b) which are positioned one symmetrically either side of the longitudinal axis (5) when viewed in plan (FIG. 2). These extend from (a typically higher) point (62) on the body mounting portion (2) to a lower point (63) on the accessory body portion (3), though could equally well ascend from the body mounting portion (2) to the accessory body portion (3). These are typically hydraulic and operable (in preferred embodiments) in a manner where they can work to elevate each end of the accessory body portion (3) to different elevations relative to the ground. This provides for a roll pitch of the accessory portion relative to the vehicle mounting portion, such as illustrated in FIGS. 7 and 8. Further reference, in terms of specific design using this link system, can be found in publicly available patent document WO 2015/190937 A1.

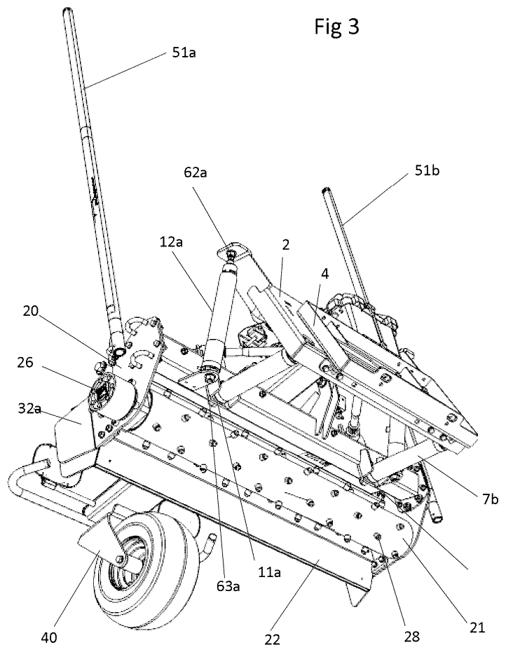

The accessory body portion (3) typically comprises a frame including side guards/shields (20) to which accessories can be mounted. In the embodiment of FIGS. 1 through 4 these accessories comprise a powered drum (21) and a pivoting blade portion (22). Single (24), or dual hydraulic motors (one at each end of the drum (21)) power rotation of the drum in both clockwise and anticlockwise directions, though preferred embodiments use just the one for weight reduction and simplicity.

The drum (21) is essentially a cylinder, nominally of around 150 mm diameter. Features typically protrude outwardly from its outer surface. These protrusions may be added or formed into the drum. Various features can be utilised as needed, though in this preferred embodiment studs with replaceable tungsten carbide (or other materials) teeth are used. There is a variety of user choice here.

The blade portion (22) is typically ahead of the powered drum (21)—i.e. the powered drum is typically between the blade portion (22) and the body mounting portion (2). At each end of the blade portion (22) a pivot joint (29a, b) with the frame (20) allows the blade portion (22) to pivot forwardly and upwardly to expose the drum portion (21) to the front.

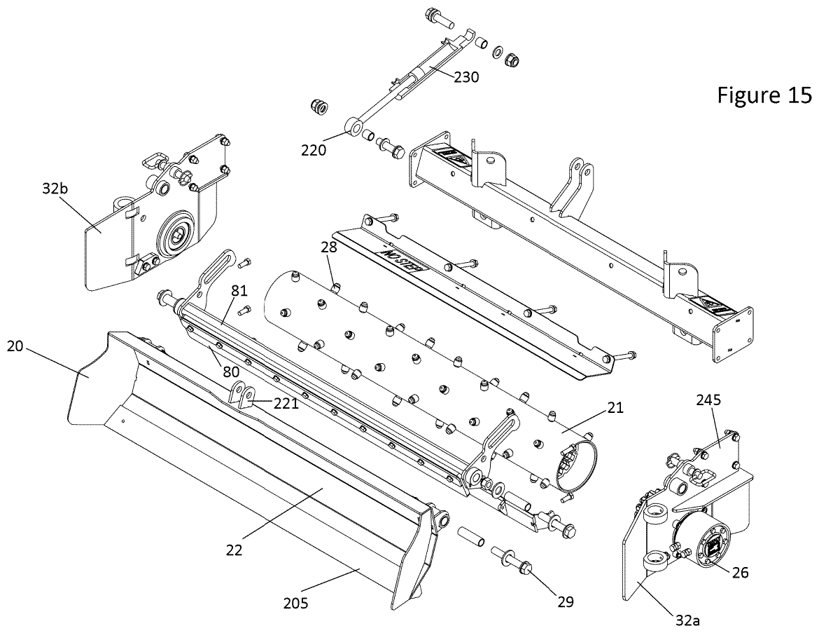

An actuator (30) or other link can control/maintain the pivoting position of the blade portion (22). A concave front face to the blade portion also makes it easier to push large objects ahead of the accessory, such as when clearing large objects from a site. It can also be useful for general bulk grading and levelling of a site, including when spreading aggregate to be blended by the trailing rotating drum. In FIG. 15 this actuator (230) with its connections (220, 221) to the blade portion (22) can be seen more clearly.

Optional pivoting wings (32a, b) can pivot inwardly and outwardly about a vertical axis to control or manage outward spread (or gathering) of loose ground material during operation.

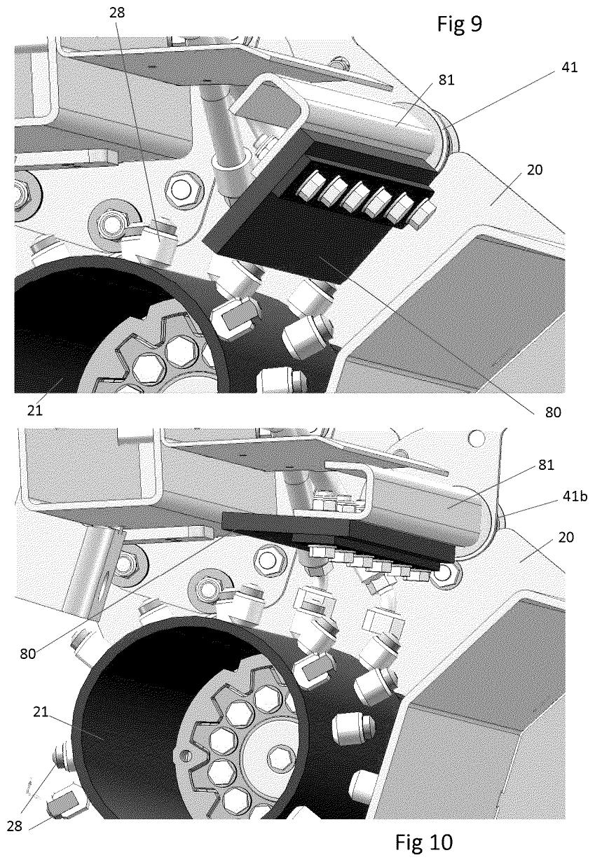

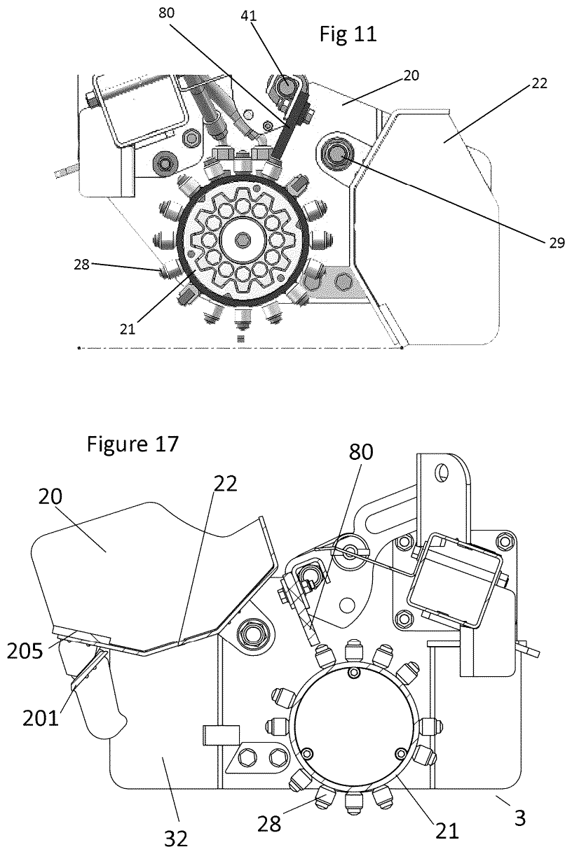

A flexible blade (80) extends the width of the drum and is pivotably connected (41a, b) at each end to allow it to pivot between operational and non-operational positions in close proximity to, and distanced from, the outer ends of the features (28) on the drum (21) respectively. This can be used to wipe and dislodge clumped material on the drum (21) or its features (28), as well as to hold clumps of aggregate in place until the action of the rotating drum (21) helps break them down into smaller lumps. A rigid metal holder (81) holds the flexible blade (80) in position and connects to the pivots (41a, b). FIGS. 9 and 10 show the flexible blade (80) in operational (FIG. 9) and retracted (FIG. 10) positions.

The flexible blade mechanism (80) can be manually operated and positioned, though remote control by the user through an actuator or the like can be considered.

A turnable (left/right) rotatable wheel (40) or caster is provided on some embodiments and mounted to an arm (41) extending from the body mounting portion (2). An optional pivot (42) may be provided on the arm (44) to allow it to fold up and over itself—such as during storage. A suitable locking mechanism is provided to maintain the folding forward end in the desired folded or unfolded position.

A boom (51a, b) for the mounting of sensor/guidance equipment is optional provided either side of the accessory body portion (3). This includes components of various levelling systems.

In a second embodiment, a different link arrangement is used where the links of the first set (106a, b) and second set (107a, b) are all substantially parallel with each other. Their connection points to the vehicle attachment body portion (2) when viewed from the front or rear are disposed in a rectangular or trapezoid pattern. Similarly for their connection points to the accessory body portion (3). The numbering of the second embodiment is the same as for the first embodiment, except the numerals are 100 higher in value.

In the second parallel link type embodiment in FIG. 12 additional link (150) is provided to limit sideways movement of the accessory body portion (3) to the vehicle attachment body portion (2). If this is a fixed length link (150) then so relative lateral movement is permitted. If an actuator is used to adjust length, then sideways shifting of the accessory body portion (3) is permitted and the side shifting optional feature is provided for. A pivoting type joint (151a, b) is typically used at each end of the link (150). One end is attached to a point or feature on the accessory body portion (3) while the other end connects to the body mounting portion (2).

The link arrangement and side-shifting option of FIG. 12 is also given in more detail in patent specification EP 3623532 A1 and reference may be made thereto for additional construction detail.

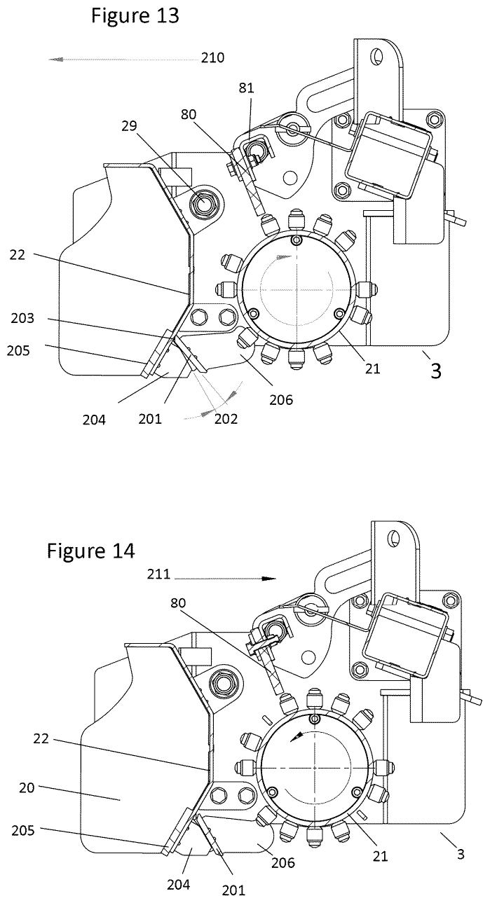

Some additional detail is given in FIGS. 13 through 17 to assist the understanding of a skilled addressee of the art, and in order to perform the invention, along with the following description.

FIGS. 13 and 14 show an embodiment of the invention where a second pivotable blade edge (201) is provided. For simplicity and clarity only the accessory body portion (3) is shown. The blade edge portion (201) is pivoted at its top (203) and is capable of a limited range of movement indicated by (202).

Stops (204) limit pivoting of the pivotable blade edge (201) in the forward direction (towards left in the figure) while further stops (206) limit pivoting in the reverse direction. The degree of pivoting, typically around 8-15°, is shown (202). In practice, when the blade portion (22) is lowered, the lowest the lowermost edge of pivotable blade edge (201) can attain is the same (or close to) the lowermost point on the bottom edge portion (205) of the blade assembly (22). In this double blade edge embodiment, blade edge levelling is possible in both forward and rearward directions, for an improved final finish, and thus it is desirable that the acting blade edge (201, 205) has around the same lowest points in both directions.

In operation, when the embodiment of FIG. 13 is travelling in the forward direction (210), the leading blade edge (205) acts upon ground material. As can be seen, this blade edge (205) has a forward rake with respect to the direction of travel (210). Here the pivoting blade edge (201) pivots upwardly (as is shown in the figure) so that its bottommost edge is slightly higher in elevation than the bottommost edge of blade edge (205). This means that the pivotable blade edge (201) drags across the top of the ground levelled by leading blade edge (205) and does not disrupt blade edge's (205) levelling.

FIG. 14 shows the same accessory portion (3) travelling in the reverse (211) direction. Here the pivoting blade edge (201) pivots down and rests against the stops (204). Its (201) bottommost edge is now level (or fractionally lower) than that of blade edge (205) allowing the pivoting blade edge (201), with its forward rake (relative to the direction of travel), to act as the primary levelling edge. It is noted, that in real world practice, reverse levelling/grading typically produces a finer and more perfect finish than forward levelling, due to a number of reasons (e.g. pushing an accessory ahead of the vehicle can cause it to dig into the ground if obstacles or bulk material are encountered, while a trailing accessory is less likely to exhibit this effect). The pivoting blade edge (201) takes advantage of this known observation, and uses its lowermost edge to maximise the fineness of any reverse direction finishing.

It is also noted that an operator can reverse the direction of drum rotation during reverse travel, if desired or necessary due to the nature of the ground surface. It is also noted that the pivoting nature of the pivoting blade edge (203) also helps prevent the build up of material between the blade edges (201, 205) which could be difficult to clear if both edges were fixed. The pivoting action (201) helps prevent build up as the accessory portion (3) changes between forward and reverse travel during typical operation.

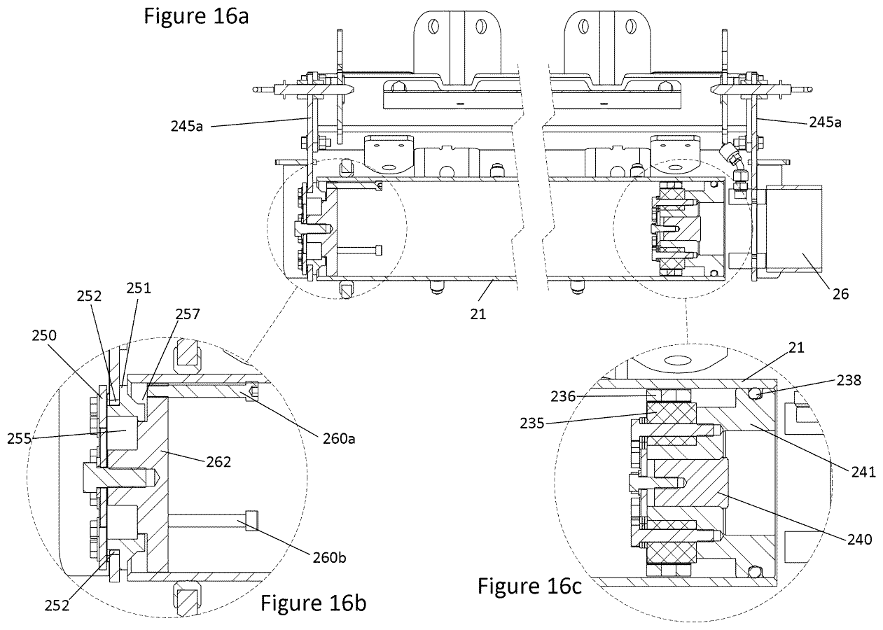

FIGS. 16 show a coronal plane cross section through the drum. In these embodiments a hollow drum (21) is used, and the motor (26) located behind a supporting shield portion (245) to protect it from the bulk of material being actively processed by the ground working accessory. An end seal (238) and end element (241) seal the end of the drum (21). Motor (26) drive output (240) is coupled to a nylon gear wheel (235) which couples with internally toothed gear flange (236) to transmit drive to the drum (21). Other materials than nylon can be used, though nylon does have some shock absorbing properties for when the motor (26) starts up or changes direction.

At the drum retaining end (FIG. 16b) a two piece flange assembly (250, 251) couples together to pass through an aperture (252) in the supporting shield portion (245b). This aperture is slightly larger than the flange assembly (250, 251) passing through so that some radial play (away from the rotational axis of drum (21) is possible. In practice this accommodates any slight eccentricity and rotational peturbations of the rotation of the drum (21) due to manufacturing tolerances. By accommodating such variations in rotation in this manner, a standard robust cylindrical bearing (255) can be used rather than the more expensive and vulnerable spherical bearing used in the art.

Also, as can be seen in the region of (257), the labyrinth nature of the flange (251) and drum end piece (262) make it more difficult to foreign materials to enter and damage the bearing than standard prior art designs.

Also, as drum cross-sectional tolerances may not be perfectly circular, unless we use very expensive machining methods for drum fabrication, we need a method to readily locate the supporting drum insert (262) so that it is as close as possible to the true rotational centre of the drum. In this embodiment three cap head bolts (260) extend inwardly from the insert (262). The bolts (260) splay slightly (in a radial direction from the drum rotational axis) outwardly so they bear against the inside of the drum (21) with a mild interference type action. The resulting tension on each bolt (260) helps centre the end piece (262) accurately within the drum regardless of irregularities from the inner surface being a true and perfect circle. Other numbers of bolts (260) may be used.

The detail in these FIGS. 16 represent details, to assist a skilled addressee of the art in the working of the invention herein, and relate to the best known method and embodiment known to the inventor at the time of draughting this specification. It should be appreciated that this detail is not meant to be limiting, and mechanical variations and functional equivalents may be applied and incorporated in various other embodiments of the invention.

FIG. 17 is an additional figure which clearly demonstrates the blade portion (22) in a raised/retracted configuration.

Aspects of the present invention have been described by way of example only and it should be appreciated that modifications and additions may be made thereto without departing from the spirit or scope of the present invention as described herein.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor when developing this invention.

1. A ground working accessory for a vehicle comprising:
a body attachment portion, including attachment means to a vehicle, and
an accessory body portion;
the body attachment and accessory body portions being connected by a portion connecting linkage set comprising linkages permitting at least vertical travel of the accessory body portion relative to the body attachment portion;
the accessory body portion comprising a lateral rotatable powered drum assembly, and a forward blade assembly portion whose bottom edge may be raised and lowered in elevation relative to the lateral rotatable powered drum assembly.

2. The ground A ground working accessory for a vehicle, as claimed in claim 1, in which the accessory body portion includes side guards on either side thereof to which each end of the lateral rotatable powered drum assembly is attached respectively.

3. The ground working accessory for a vehicle, as claimed in claim 2, in which the lateral rotatable powered drum assembly has an externally offset driving motor, of which at least part is position on the alternate side of a said side guard than the drum itself.

4. The ground working accessory for a vehicle, as claimed in claim 3, in which the lateral rotatable powered drum assembly is connected, at its end distal the motor to a flange assembly sandwiching a said side guard within it, and wherein a portion of said flange assembly passes through an aperture in said side guard of greater diameter than the portion passing therethrough, such that the flange is allowed limited planar movement within the plane of the aperture said sideguard.

5. The ground working accessory for a vehicle, as claimed in claim 1, in which there is a powered actuator effecting raising and lowering of said forward blade assembly portion.

6. The ground working accessory for a vehicle, as claimed in claim 1, in which there are stops for limiting the lowest position of the forward blade assembly portion.

7. The ground working accessory for a vehicle, as claimed in claim 1, in which the lowest portion of said forward blade assembly portion is capable of being below the lowest point on said lateral rotatable powered drum assembly.

8. The ground working accessory for a vehicle, as claimed in claim 1, in which the bottommost edge of the forward blade assembly portion comprises a pivoting blade edge capable of pivoting about a substantially lateral axis.

9. The ground working accessory for a vehicle, as claimed in claim 8, in which said blade edge is capable of any one or more of:
pivoting in a rearward direction;
pivoting in a forward direction;
being fixed against pivoting.

10. The ground working accessory for a vehicle, as claimed in claim 1, in which the forward blade assembly portion in contoured concavely and rearwardly to facilitate driving material in a forward direction before it.

11. The ground working accessory for a vehicle, as claimed in claim 1, in which the portion connecting linkage sets comprises four linkages in which the four linkages are arranged, when the accessory body portion is not raised nor lowered relative to the body attachment portion, such that:
a first set of two linkages which are substantially at the same elevation when viewed from the side and are substantially parallel to each other when viewed from above, and
a second set of two linkages which are substantially at the same elevation when viewed from the side and are either:
(i) substantially parallel to each other when viewed from above, or
(ii) converge towards the longitudinal centre axis of the ground working accessory when viewed in plan.

12. The ground working accessory for a vehicle, as claimed in claim 1, in which the portion connecting linkage sets comprises three linkages in which the three linkages are arranged, when the accessory body portion is not raised nor lowered relative to the body attachment portion, such that:
a first set of two linkages are substantially at the same elevation when viewed from the side and which are substantially parallel to each other when viewed from above, and
a single additional linkage at a different elevation, when viewed from the side, than the first set of two linkages, and wherein the single additional linkage lies near and substantially parallel to the longitudinal centre axis of the ground working accessory.

13. The ground working accessory for a vehicle, as claimed in claim 1, in which the linkages of the portion connecting linkage sets include pivotable connections at their ends which permit movement of the accessory body portion comprising one or more of:
up and down movement of the accessory body portion relative to the body attachment portion, and
rotational movement of the accessory body portion about a rotation axis parallel to the longitudinal centre axis of the ground working accessory.

14. The ground working accessory for a vehicle, as claimed in claim 13, in which there are provided one or more actuators effecting permitted movements as defined in claim 13.

15. The ground working accessory for a vehicle, as claimed in claim 1, in which there is provided a forward wheel assembly comprising either or both of a wheel(s), or wheel(s) mounted on a turnable carriage.

16. The ground working accessory for a vehicle, as claimed in claim 1, in which there is provision for mounting booms for affixing accessories, including guidance sensors.
